(19) United States
(12) Patent Application Publication
(10) Pub. No.: US 2016/0222198 A1
(43) Pub. Date: Aug. 4, 2016

(54) SUGARCANE-BASED PACKAGING FOR CONSUMER PRODUCTS

(71) Applicant: GREENOLOGY PRODUCTS, INC., RALEIGH, NC (US)

(72) Inventor: ADAM MCCARTHY, RALEIGH, NC (US)

(73) Assignee: GREENOLOGY PRODUCTS, INC., RALEIGH, NC (US)

(21) Appl. No.: 15/010,378

(22) Filed: Jan. 29, 2016

Related U.S. Application Data
(60) Provisional application No. 62/110,106, filed on Jan. 30, 2015.

(51) Int. Cl. C08L 23/06

(52) U.S. Cl. CPC C08L 23/06

(57) ABSTRACT

Sugarcane-based packaging for consumer products is provided. More particularly, packaging for consumer products comprising a sugarcane-based resin and at least one of a post-consumer recycled resin, a post-industrial recycled resin, a virgin petroleum-based resin, and combinations thereof is provided.

### CROSS-REFERENCE TO RELATED APPLICATIONS

This application claims the benefit of U.S. Provisional Application No. 62/110,106, filed Jan. 30, 2015, which is incorporated herein by reference in its entirety.

### TECHNICAL FIELD

The presently disclosed subject matter relates generally to sugarcane-based packaging for consumer products. More particularly, the presently disclosed subject matter relates packaging for consumer products comprising a sugarcane-based resin and at least one of a post-consumer recycled resin, a post-industrial recycled resin, a virgin petroleum-based resin, and combinations thereof.

### BACKGROUND

Packaging for consumer products including household cleaning products, such as laundry detergent, automatic dishwashing detergent, and cleaning compositions, and personal care products, such as shampoo, conditioner, and liquid soap, typically is made from plastics comprising polymers made from non-renewable, fossil-based resources, such as petroleum, natural gas, and coal. For example, packaging for consumer products often is derived from petroleum-based high-density polyethylene (HDPE) resin. Accordingly, there is a need for packaging for consumer products that is made from renewable materials, offers the same functionality as HDPE resin, and is 100% recyclable.

### SUMMARY

In some aspects, the presently disclosed subject matter provides a container comprising between about 0.1% to about 80% sugarcane-based resin, in some aspects, between about 5% to about 80% sugarcane-based resin, and in other aspects, between about 25% to about 80% sugarcane-based resin; between about 20% to about 99.9%, in some aspects, between about 20% to about 95%, and in other aspects, between about 20% to about 75% of at least one of a post-consumer recycled resin, post-industrial recycled resin, and a virgin petroleum-based resin, and combinations thereof, and optionally between about 0.0% and about 2.5% colorant.

In particular aspects, the sugarcane-based resin, the post-consumer recycled resin, the post-industrial recycled resin, and the virgin petroleum-based resin are each independently selected from the group consisting of polypropylene, polyethylene, and polyethylene terephthalate.

In yet more particular aspects, the container comprises about 49% sugarcane-based resin, about 49% post-consumer resin, and about 2% colorant.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

Having thus described the presently disclosed subject matter in general terms, reference will now be made to the accompanying Figures, which is not necessarily drawn to scale, and wherein:

FIG. 1A is a scheme illustrating the preparation of green polyethylene (PE) from sugar cane;

FIG. 1B is a scheme comparing the carbon footprint of polyethylene prepared from sugar cane with the carbon footprint of petroleum-based polyethylene; and

FIG. 1C is a representative consumer product container, a laundry detergent bottle, of the presently disclosed subject matter.

### DETAILED DESCRIPTION

The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims.

The presently disclosed subject matter, in some embodiments, provides a container comprising between about 0.1% to about 80%, including 0.1%, 0.5%, 1%, 5%, 10%, 15%, 20%, 25%, 30%, 35%, 40%, 45%, 50%, 55%, 60%, 65%, 70%, 75%, and 80% of a resin derived from a renewable resource; between about 20% to about 99.9%, including 20%, 25%, 30%, 35%, 40%, 45%, 50%, 55%, 60%, 65%, 70%, 75%, 80%, 85%, 90%, 95%, 99%, 99.5%, and 99.9% of at least one of a post-consumer recycled resin, post-industrial recycled resin, and a virgin petroleum-based resin, and combinations thereof, and optionally, between about 0.0% and about 2.5%, including 0.0%, 0.1%, 0.5%, 1.0%, 1.5%, 2.0%, and 2.5%, of a colorant.

In some embodiments, the presently disclosed subject matter provides a container comprising between about 0.1% to about 80% sugarcane-based resin, in some embodiments, between about 5% to about 80% sugarcane-based resin, and in other embodiments, between about 25% to about 80% sugarcane-based resin; between about 20% to about 99.9%, in some embodiments, between about 20% to about 95%, and in other embodiments, between about 20% to about 75% of at least one of a post-consumer recycled resin, post-industrial recycled resin, and a virgin petroleum-based resin, and combinations thereof, and optionally between about 0.0% and about 2.5% colorant.

In particular embodiments, the container comprises about 49% of a resin derived from a renewable resource, e.g., a sugarcane-based resin, about 49% post-consumer resin, and about 2% colorant.

The presently disclosed container comprises at least one resin derived from a renewable resource. As used herein, a “renewable resource” is one that is produced by a natural process at a rate comparable to its rate of consumption (e.g., within a 100-year time frame). The resource can be replenished naturally or via agricultural techniques. Nonlimiting examples of renewable resources include, but are not limited to, plants (e.g., sugarcane, beets, corn, potatoes, citrus fruit, woody plants, lignocellulosics, hemicellulosics, and cellulosic waste), animals, fish, bacteria, fungi, and forestry products. These resources can be naturally occurring, hybrids, or genetically-engineered organisms. In contrast, natural resources such as crude oil, coal, natural gas, and peat, which take longer than 100 years to form, are not considered renewable resources.

Nonlimiting examples of renewable polymers include polymers produced directly from organisms, such as polyhydroxyalkanoates (e.g., poly(beta-hydroxyalkanoate), poly(3-hydroxybutyrate-co-3-hydroxyvalerate), and bacterial cellulose; polymers extracted from plants and biomass, such as polysaccharides and derivatives thereof (e.g., gums, cellulose, cellulose esters, chitin, chitosan, starch, chemically modified starch), proteins (e.g., zein, whey, gluten, collagen), lipids, lignins, and natural rubber; and polymers derived from naturally sourced monomers and derivatives, such as bio-polyethylene, bio-polypropylene, polytrimethylene terephthalate, polylactic acid, NYLON 11, alkyd resins, succinic acid-based polyesters, and bio-polyethylene terephthalate.

Examples of renewable materials include bio-polyethylene, bio-polyethylene terephthalate, and bio-polypropylene. As used herein and unless otherwise noted, “polyethylene” encompasses high density polyethylene (HDPE), low density polyethylene (LDPE), linear low density polyethylene (LLDPE), and ultra low density polyethylene (ULDPE). As used herein and unless otherwise noted, “polypropylene” encompasses homopolymer polypropylene, random copolymer polypropylene, and block copolymer polypropylene.

As used herein, the prefix “bio-” is used to designate a material that has been derived from a renewable resource.

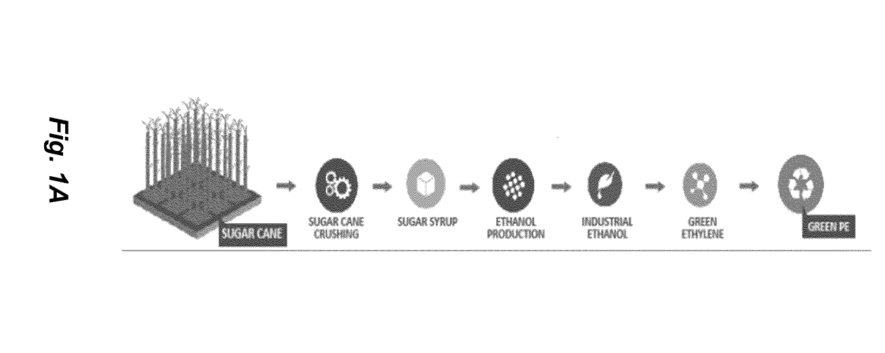

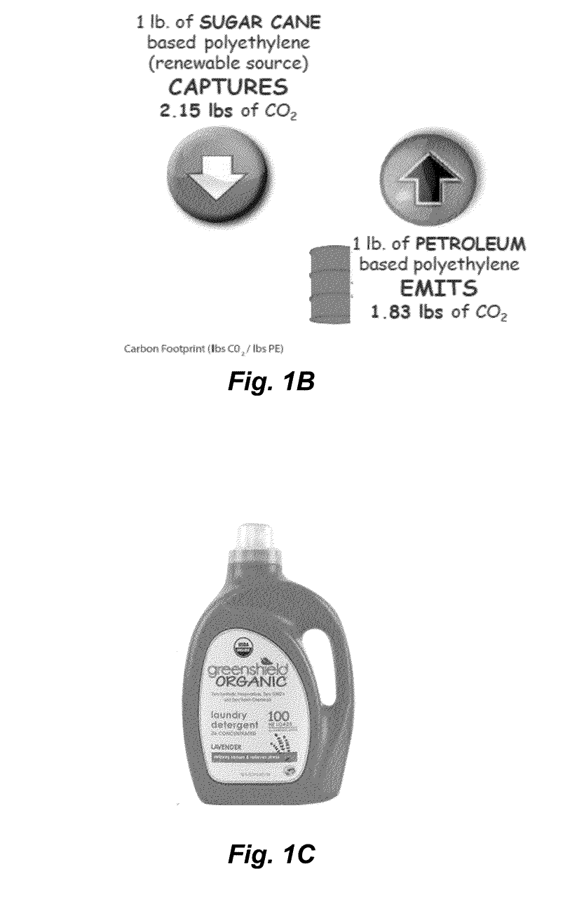

In particular embodiments, the presently disclosed containers comprise a blow-molding grade of sugarcane-based HDPE. Such sugarcane-based HDPE can be considered to be a “drop-in” bio-based plastic that features the same properties and functionalities as a fossil-based material, and can be processed, used, recycled, and recovered in the same way as petroleum-based polyethylene. Accordingly, such materials can be used in the same bottle molds as used with petroleum-based polyethylene. For example, the sugarcane-based HDPE can be used for 24- and 32-oz cleaner bottles and 50-, 60-, 100-, 140-, 150-, 200-oz laundry detergent bottles (see FIG. 1C).

Sugarcane is an advantageous raw material for use in fabricating containers for consumer products. See FIG. 1A for a schematic showing a representative method for preparing green polyethylene (PE) from sugar cane. Sugarcane is both sustainable and carbon negative. Referring now to FIG. 1B, for every 1 lb. of petroleum-based resin that is produced, 1.83 lbs. of carbon dioxide is emitted into the atmosphere, thereby contributing to the greenhouse effect. Conversely, for every 1 lb. of sugarcane-based resin that is planted, cultivated, undergoes photosynthesis and then produced, 2.14 lbs. of carbon dioxide are captured from the atmosphere. Thus, the sugarcane contribution to the total carbon footprint is carbon negative. The delta between petroleum-based virgin high density polyethylene, for example and sugar cane-based high density polyethylene is 3.98, thereby greatly reducing the greenhouse gas effect brought about by carbon dioxide emissions.

In addition to comprising at least one resin derived from a renewable resource, the presently disclosed containers comprise at least one of a post-consumer recycled resin, post-industrial recycled resin, and a virgin petroleum-based resin, and combinations thereof. As used herein, “recycled” materials encompass post-consumer recycled (PCR) materials, post-industrial recycled (PIR) materials, and mixtures thereof. In some embodiments, the presently disclosed container comprises recycled high density polyethylene (HDPE), recycled polyethylene terephthalate (PET), recycled polypropylene (PE), recycled linear low-density polyethylene (LLDPE), or recycled low-density polyethylene (LDPE).

In yet other embodiments, the presently disclosed containers can comprise a regrind material. As used herein, “regrind” material comprises thermoplastic waste material including, but not limited to, sprues, runners, excess parison material, and reject parts from injection and blow molding and extrusion operations, which has been reclaimed by shredding or granulating.

The presently disclosed containers can optionally comprise a colorant. Representative colorants suitable for use with the presently disclosed containers include, but are not limited to, black, white, and color masterbatch, including red, yellow, orange, blue, green, purple, and the like, and international pantone colorants.

Advantageously, the presently disclosed containers are 100% recyclable. As used herein the term “recyclable,” and derivatives thereof, refers to the ability of the components of an article (e.g., the container) to enter into current recycling streams established for petroleum-derived resins (e.g., including HDPE, PET, PP polymers) without compromising the suitability of the recycled resin for use in remaking components.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A container comprising between about 0.1% to about 80% sugarcane-based resin, between about 20% to about 99.9% of at least one of a post-consumer recycled resin, post-industrial recycled resin, and a virgin petroleum-based resin, and combinations thereof, and optionally between about 0.0% and about 2.5% colorant.

2. The container of claim 1, wherein the container comprises between about 5% to about 80% sugarcane-based resin, between about 20% to about 95% of at least one of a post-consumer recycled resin, post-industrial recycled resin, and a virgin petroleum-based resin, and combinations thereof, and optionally between about 0.0% and about 2.5% colorant.

3. The container of claim 1, wherein the container comprises between about 25% to about 80% sugarcane-based resin, between about 20% to about 75% of at least one of a post-consumer recycled resin, post-industrial recycled resin, and a virgin petroleum-based resin, and combinations thereof, and optionally between about 0.0% and about 2.5% colorant.

4. The container of claim 1, wherein the sugarcane-based resin, the post-consumer recycled resin, the post-industrial recycled resin, and the virgin petroleum-based resin are each independently selected from the group consisting of polypropylene, polyethylene, and polyethylene terephthalate.

5. The container of claim 1, wherein the container comprises about 49% sugarcane-based resin, about 49% post-consumer resin, and about 2% colorant.
